(19) United States
(12) Patent Application Publication
(10) Pub. No.: US 2010/0266245 A1
(43) Pub. Date: Oct. 21, 2010

(54) Fiber termination for fiber optic connection system

(75) Inventor: James M. Sabo, Harrisburg, PA (US)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/386,388

(22) Filed: Apr. 16, 2009

(51) Int. Cl. G02B 6/36

(52) U.S. Cl. 385/79

(57) ABSTRACT

A fiber termination (10) for a fiber optical connection system includes a cable (107) having a number of fibers (1070) therein; a ferrule member (103) combined with the fibers, with front ends of the fibers exposed around a front end portion of the ferrule member; and a lens member (101) adhesively attached to the front end portion of the ferrule member.

### BACKGROUND OF THE INVENTION

1. Field of the Invention

The present invention generally relates to a fiber optic connection system, and more particularly to a fiber optic connection system with a fiber termination which is common to plug side and receptacle side thereof.

2. Description of Related Art

A multi-fiber optical connector has been widely used in telecommunication. For example, U.S. Pat. No. 5,214,730 issued to Nagasawa on May 25, 1993 discloses a type of multi-fiber optical connector. The connector includes a plurality of optical fibers; a connector plug member made of a plastic material, having a connecting facet on which end faces of the optical fibers to be connected with other optical fibers are arranged with the end faces of the optical fibers projecting out of the connecting facet, the connecting facet being inclined with respect to an axial direction along optical axes of the optical fibers by an angle which is larger than a total reflection critical angle of light beams transmitted through the optical fibers, and the connector plug member further including guide pin insertion holes located on the connecting facet for receiving guide pins for aligning the multi-fiber optical connector plug with another multi-fiber optical connector plug, where the optical fibers are arranged on the connecting facet between the guide pin insertion holes along a transverse direction.

However, the connecting facet of the connector should be directly contacting the connecting facet of the other connector (complementary connector) to have the fibers of the two connectors well mated such that the light beams can be transmitted through the optical fibers. If a gap exists between the connecting facets of the two connectors, or some dirt attached to the facet, which may have the light beams transmitting failed.

### SUMMARY OF THE INVENTION

Accordingly, an object of the present invention is to provide a fiber optic connection system with a fiber termination which is common to plug side and receptacle side thereof.

In order to achieve the object set forth, a fiber termination for a fiber optical connection system comprises a cable having a number of fibers therein; a ferrule member combined with the fibers, with front ends of the fibers exposed around a front end portion of the ferrule member; and a lens member over-molded onto the front end portion of the ferrule member.

Other objects, advantages and novel features of the invention will become more apparent from the following detailed description when taken in conjunction with the accompanying drawings.

### BRIEF DESCRIPTION OF THE DRAWINGS

FIG. 1 shows a fiber optic connection system of a first embodiment in accordance with the present invention including a plug connector mating with a receptacle connector;

FIG. 2 is similar to FIG. 1, but viewed from other aspect;

FIG. 3 is an assembled, perspective view of the plug connector;

FIG. 4 is an exploded, perspective view of the plug connector;

FIG. 5 is a fiber termination (sub-assembly) for both the plug connector or the receptacle connector;

FIG. 6 is a view similar to FIG. 5, but viewed from another aspect;

FIG. 7 is perspective view of the receptacle connector adapted for mounting to a panel member;

FIG. 8 is an explode, perspective view of the receptacle connector;

FIG. 9 illustrates the receptacle connector mounted to the panel member;

FIG. 10 is a view similar to FIG. 9, but viewed from other direction; and

FIG. 11 is a cross-section view taken along line 11-11 of FIG. 1;

FIG. 12 is an assembled, perspective view of the plug connector of the second embodiment in accordance with the present invention;

FIG. 13 is an exploded, perspective view of the plug connector in FIG. 12;

FIG. 14 is a view similar to FIG. 13, but viewed from other aspect;

FIG. 15 is a fiber and copper termination (sub-assembly) for the plug connector;

FIG. 16 is a cross-section view taken along line 16-16 of FIG. 12;

FIG. 17 is the plug connector and a coupler member;

FIG. 18 illustrates the plug connector inserted into the coupler; and

FIG. 19 is a view similar to FIG. 18, but viewed from other direction.

### DETAILED DESCRIPTION OF THE INVENTION

Reference will now be made in detail to the preferred embodiment of the present invention.

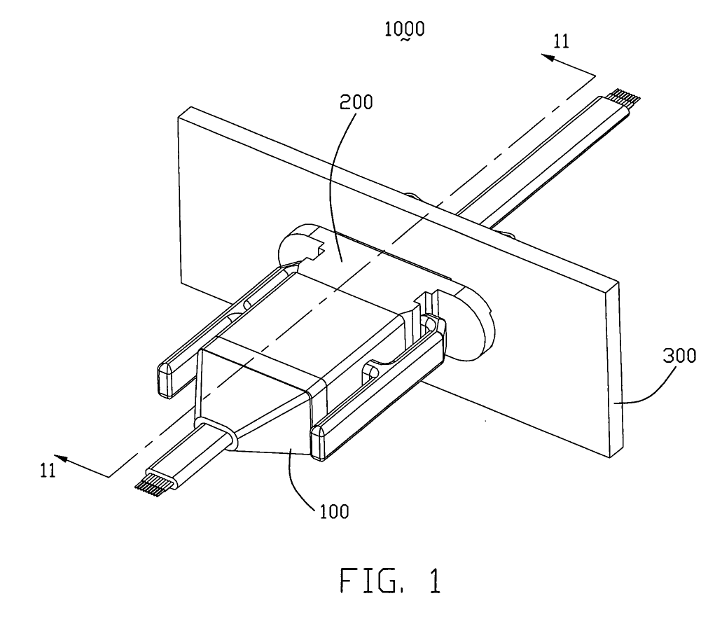

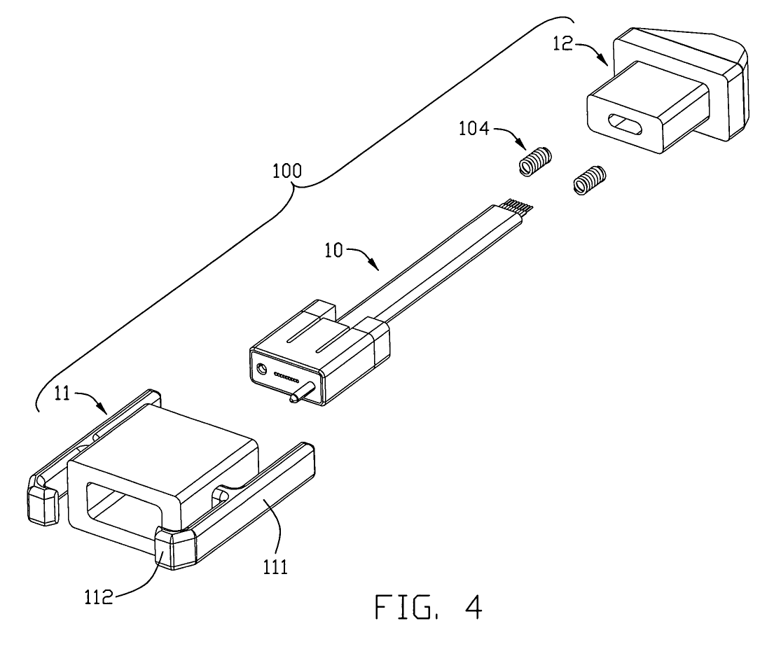

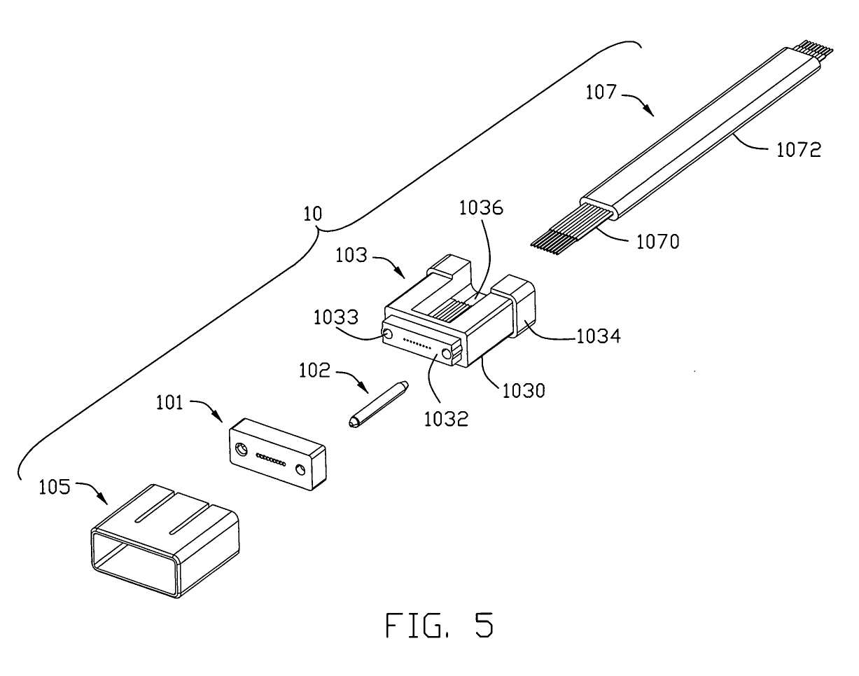

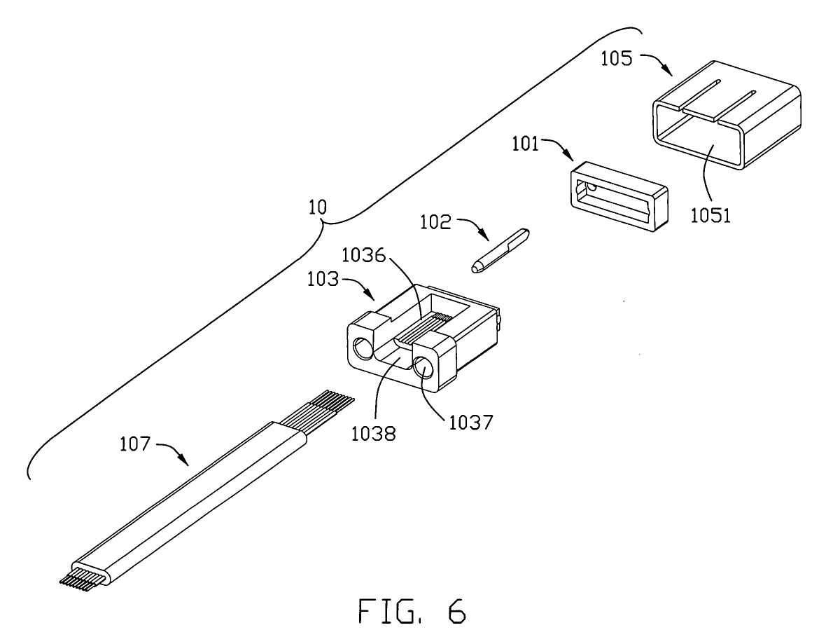

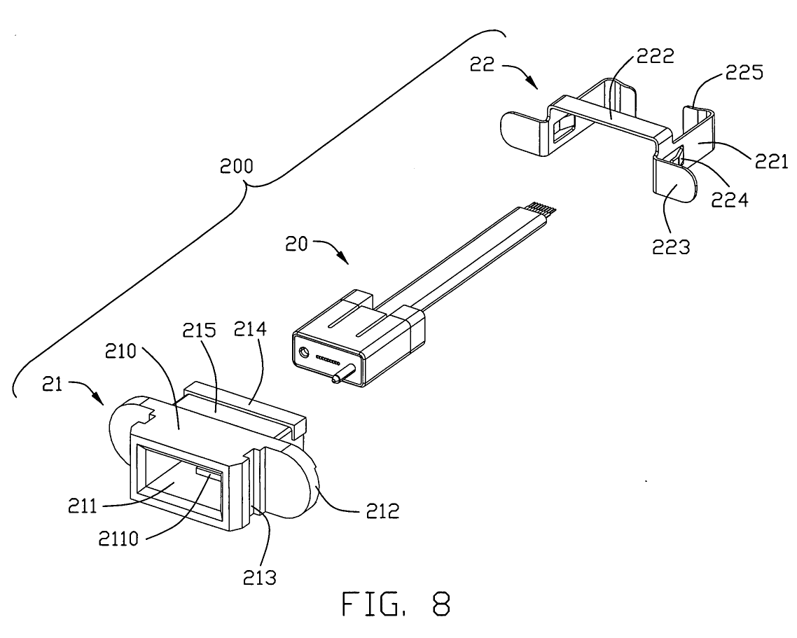

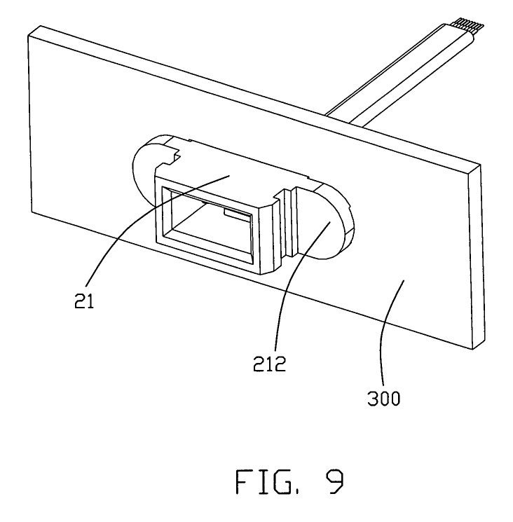

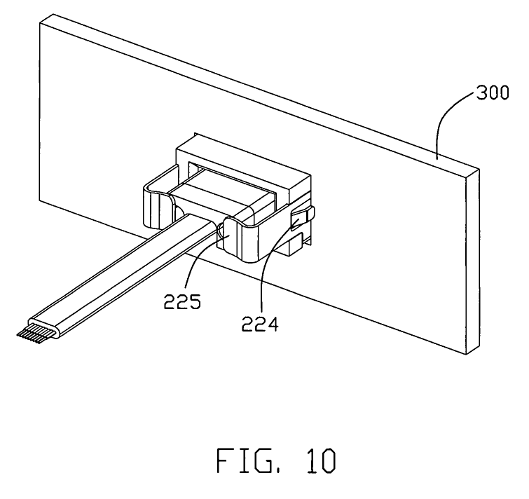

Referring to FIGS. 1-11, a fiber optic connection system 1000 of the first embodiment in accordance with the present invention includes a plug connector 100 and a receptacle connector 200.

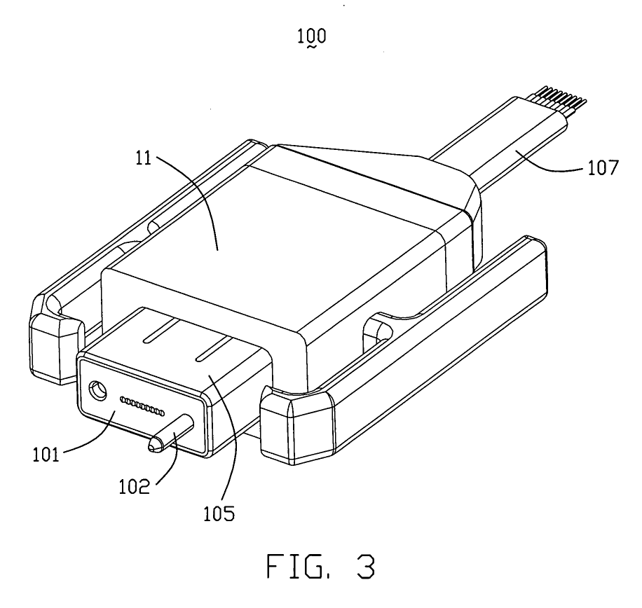

Referring to FIGS. 3-6, the plug connector 100 includes a fiber termination 10, a front cover 11 and a rear cover 12 combined with the fiber termination 10.

The fiber termination 10 comprises a lens member 101, a ferrule member 103, a metallic shielding member 105 and a cable 107. The lens member 101 is made of plastic material or glass material, etc. The ferrule member 103 includes a main portion 1030, a front end portion 1032 extending forwardly from a front surface of the main portion 1030 and a flange portion 1034 formed on a rear segment of the main portion 1030. A passageway 1036 is recessed downwardly from upper surface of a middle segment of the main portion 1030. A sunken portion 1038 is defined in a back portion of a bottom surface of passageway 1036. The metallic shielding member 105 includes a number of walls (not numbered) joined with one another to form a hollow portion 1051 thereamong. The cable 107 is of ribbon shaped and includes a number of fibers 1070 arranged in juxtaposed manner and a jacket 1072 enclosing the fibers 1070. The fibers 1070 are combined with the ferrule member 103, with a front end of each of the fibers 1070 substantially flushed with a front surface of the front end portion 1032. The lens member 103 is molded over the front end portion 1032. The metallic shielding member 105 encloses the lens member 101 the main portion 1030 and further abuts against the flange portion 1034. The fiber termination 10 further comprises an alignment pin 102 mounted to a side portion of the ferrule member 103 along a front-to-back direction and projects beyond a front surface of the lens member 101, and an alignment hole 1033 is defined in other side portion of the ferrule member 103. Two coil spring members 104 are assembled to two mounting holes 1037 which are defined in lateral sides of the rear portion of the ferrule member 103.

The method of making the fiber termination 10 comprises the steps below: providing a cable 107, with a partial of the jacket 1072 of the front segment thereof being removed away to expose the fibers 1070 outside; the fibers being epoxied to the ferrule member 103, cleaved, and then polished; the alignment pin 102 being press-fit into the ferrule member 103; the lens member 101 being over-molded or adhesively attached over the polished front face of the ferrule member 103; the metallic shielding member 105 being assembled to the lens member 101 and the ferrule member 103.

The rear cover 12 is molded or assembled over partial of the jacket 1072 adjacent to the ferrule member 103, and the front cover 11 is molded or assembled over a front segment of the rear cover 12, partial of the metallic shielding member 105 and the flange portion 1034. Two deflectable latching arms 111 are formed on lateral sides of the front cover 11, and a hook portion 112 is formed on a front end of each latching arm 111.

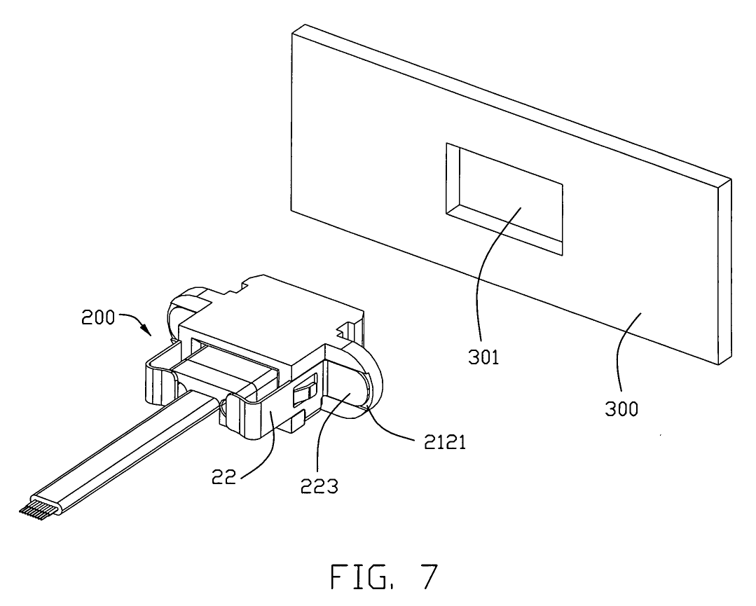

Referring to FIGS. 7-10, the receptacle connector 200 is adapted for mounting to a panel member 300. The receptacle connector 200 includes a fiber termination 20, a housing member 21 and a clip member 22 for fastening the fiber termination 20 and the housing member 21 together. The fiber termination 20 is substantially same with the fiber termination 10 of the plug connector 100, and detail description is omitted hereby.

The housing member 21 includes a body portion 210 having a number of sides (not numbered) cooperatively form a hollow portion 211 thereamong. Two tabs 2110 are disposed inside of the hollow portion 211 and formed on middle segments of inner surfaces of a top and bottom sides of the body portion 210. Two flange portions 212 extend outwardly from middle sections of lateral sides (not numbered) of the body portion 210. Two slots 213 are defined in front sections of the lateral sides of the body portion 210. The slots 213 are located in front of the flange portions 212 and adapted for locking with hook portions 112 of latching arms 111 of the plug connector 100. A bar portion 214 is formed at a rear portions of the top side and the lateral sides of the body portion 210, with a corresponding groove 215 defined in front of the bar portion 214.

The clip member 22 includes two arm portions 221 spaced apart from one another, an interconnection portion 222 for connecting the two arm portions 221 together. A positioning part 223 is formed at a front end of the arm portions 221 and laterally extends outward. A latching part 225 is formed at a rear end of the arm portions 221 and projects inwardly therefrom. The latching parts 225 provide spring pressure to the rear of the fiber termination 20 so as to keep the fiber termination 20 springably biased against the two tabs 2110. A spring part 224 is formed with the arm portion 221, arranged adjacent to the interconnection portion 222, and protruding toward the positioning part 223.

The fiber termination 20 is assembled to the housing member 21, with a lens members (not numbered) thereof accommodated in the hollow portion 211 and abutting against tabs 2110. The clip member 22 is mounted to the housing member 21, with the interconnection portion 222 located in the groove 215, the latching parts 225 holding a rear portion of a ferrule member (not numbered), and the positioning parts 223 located in cavities 2121 in the rear portion of the two flange portions 212. The receptacle connector 200 is mounted to the panel member 300, with the arm portions 221 firstly inserted into an opening 301 therein, and then the spring parts 224 passing through the opening 301, thus the spring parts 224 press onto a back surface of the panel member 300, and the positioning parts 223 together with the flange portions 212 rely against a front surface of the panel member 300. The interconnection portion 222 is received in the opening 301 of the panel member 300, and thus the clip member 22 may engage with the housing member 21 more reliably.

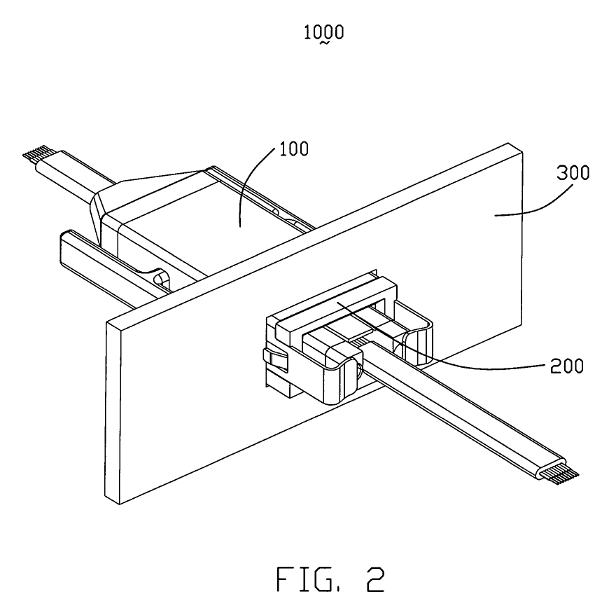

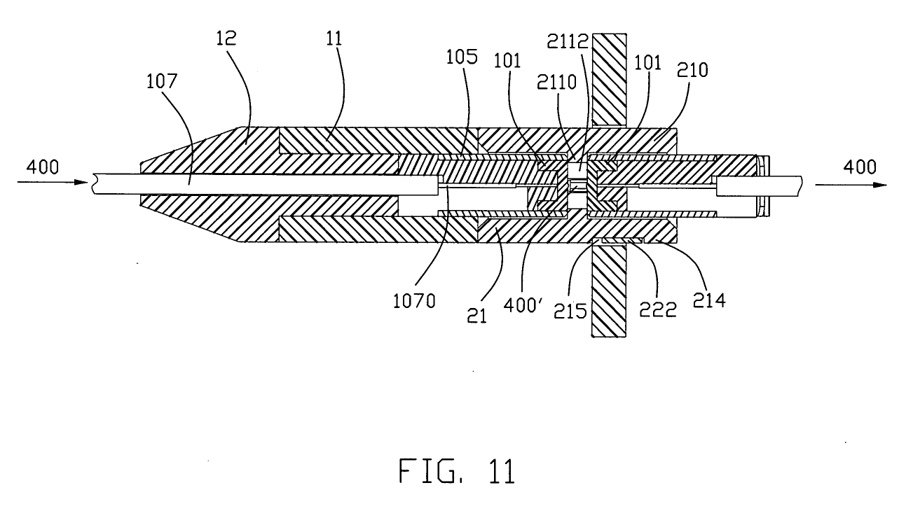

Referring to FIG. 11, in conjunction with FIGS. 1-2, which shows the plug connector 100 and the receptacle connector 200 mated together, and illustrates how a light beam 400 is transmitted therebetween. The light beam 400 firstly transmits along the corresponding fiber 1070 of the plug connector 100, then passes the lens member 101 and is expanded to be an expanded (enlarged) collimated light beam 400′, the expanded and collimated light beam 400′ passes though a gap 2112 between the plug connector 100 and the receptacle connector 200, and enters into a lens member (not numbered) of the receptacle connector 200 and is shrunk to its normal size and transmits along the fiber (not numbered) of the receptacle connector 200.

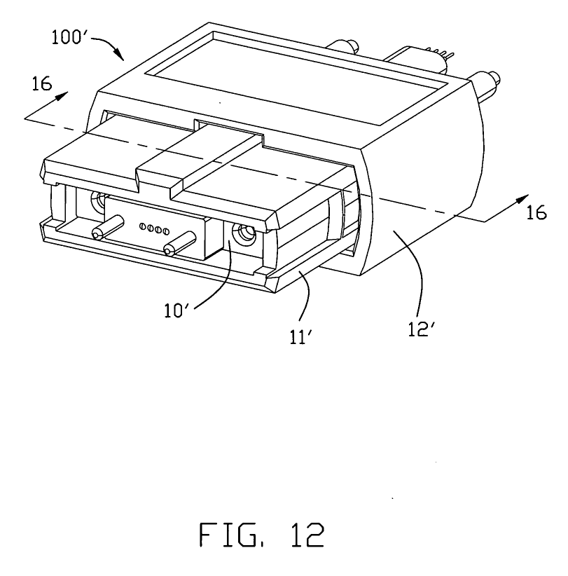

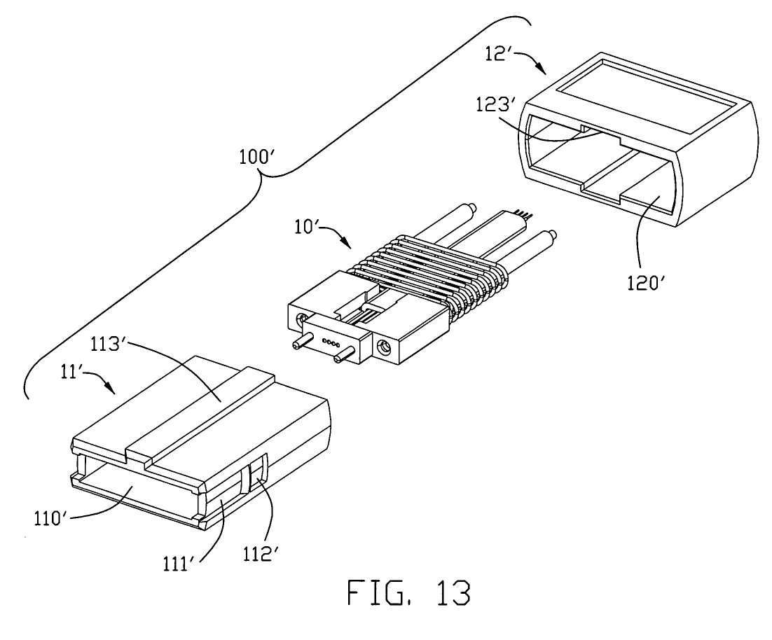

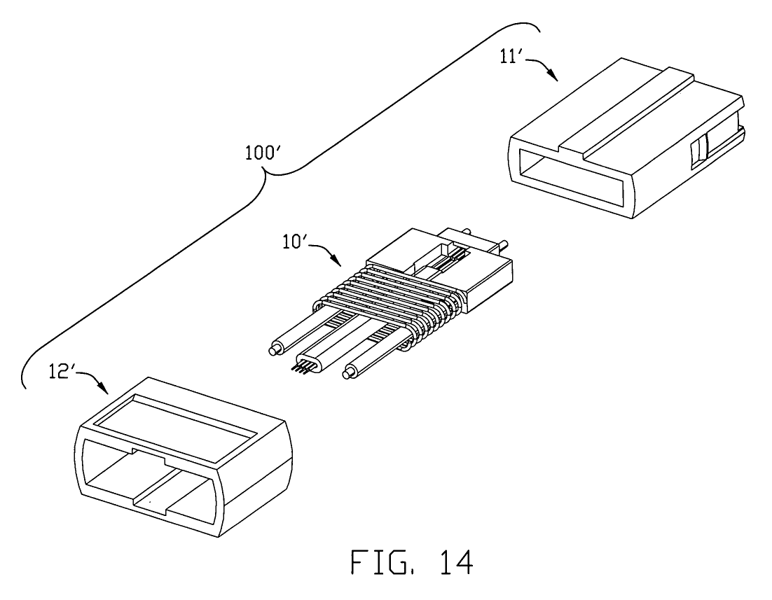

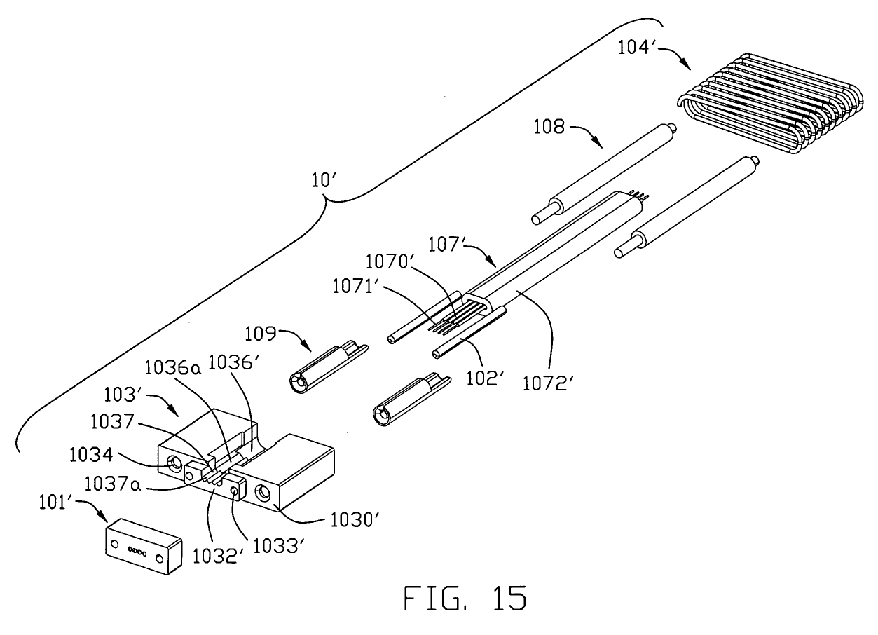

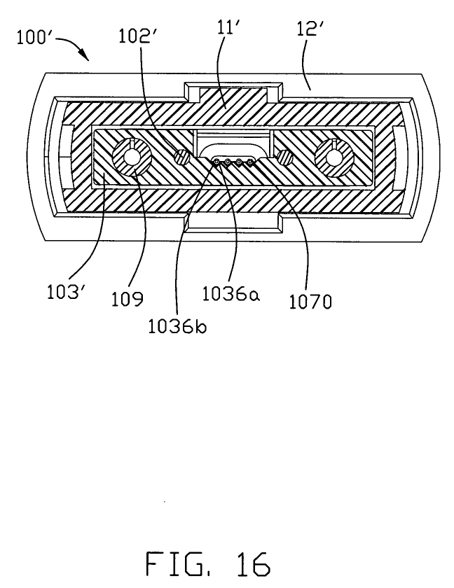

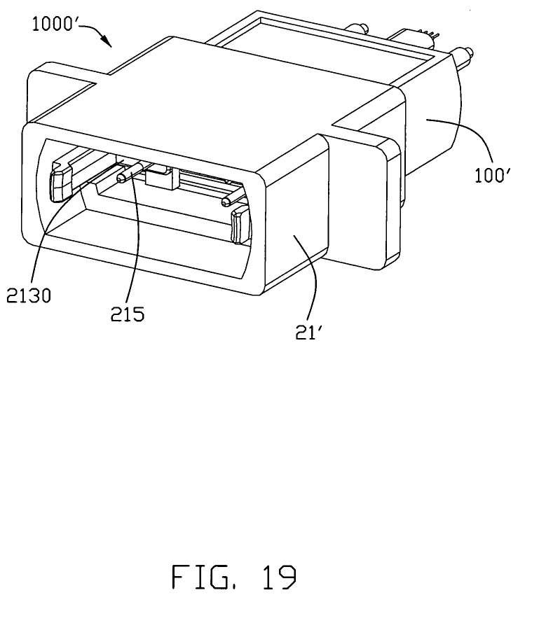

Referring to FIGS. 12-19, a fiber optic connection system 1000′ of the second embodiment in accordance with the present invention includes a plug connector 100′ and a coupler (housing member) 21′.

Referring to FIGS. 12-16, the plug connector 100′ includes a fiber termination 10′, an inner housing 11′ and a slidable outer housing 12′ assembled to the fiber termination 10′.

The fiber termination 10′ comprises a lens member 101′, one or two aligning pins 102′, a ferrule member 103′, a coil spring member 104′, a cable 107′, two wires 108, and two contacts 109. The lens member 101′ is made of plastic material or glass material, etc. The ferrule member 103′ includes a main portion 1030′, a front end portion 1032′ extending forwardly from a front surface of the main portion 1030′. A passageway 1036′ is recessed downwardly from an upper surface of a middle segment of the main portion 1030′. A cavity 1037 is recessed downwardly from an upper surface of the front end portion 1032′ and in communication with the passageway 1036′. A number of first grooves 1036a are defined in the lower portion of the front segment of the passageway 1036′, and a number of second grooves 1037a are defined in lower portion of the cavity 1037. The first grooves 1036a are located behind the second grooves 1037a. The first grooves 1036a are in accordance with and lower than the second grooves 1037a. Both the first grooves 1036a and the second grooves 1037a are of V-shaped. Two slots 1034 are defined in lateral sides of the main portion 1030′ to receive the two contacts 109 therein. Two holes 1033′ are recessed backward from lateral sides of the front end portion 1032′, and the aligning pins 102′ are inserted into the holes 1033′. The cable 107′ is of ribbon shaped and includes a number of fibers 1070′ arranged in juxtaposed manner and a jacket 1072′ enclosing the fibers 1070′. A front portion of the jacket 1072′ is removed away to expose the fibers 1072′ outside. The fibers 1070′ exposed outward are disposed in the first grooves 1036a in which glue or other adhesive materials 1036b is applied to, so that the fibers 1070′ are securely combined with the ferrule member 103′. Furthermore, core members 1071′ of the fibers 1070′ are placed in the second grooves 1037a. The two wires 108 are soldered to the contacts 109, and said the wires 108 and the contacts 109 are used for transmitting electricity. The lens member 101′ is molded over the front end portion 1032′, with the aligning pins 102′ forwardly projecting therethrough.

The inner housing 11 ′ has a number of walls joined one another together to define a hollow portion 110′. Two guiding slots 111′ are respectively defined in front segments of the lateral walls of the front cover 11′, and a locking cavity 112′ is defined in each lateral wall and located behind the corresponding guiding slots 111 ′. A key member 113′ is located on a middle section of the top wall of the front cover 11′ and extends along a front to back direction. The fiber and copper termination 10′ is received in a front segment of the hollow portion 110′. The coil spring member 104′ is assembled to the cable 107′ and the wires 108, and further arranged in a back segment of the hollow portion 110′. The outer housing 12′ has a number of walls joined one another together to define a receiving space 120′ to accommodate the inner cover 11′ therein. A keyway 123′ for matching with the key member 113′ is defined in an internal side of the top wall of the rear cover 12′.

The coupler (housing member) 21′ includes a body portion 210′ having a number of walls cooperatively form a hollow portion 211′ thereamong. Two flange portions 212′ project outwardly from middle sections of lateral sides (not numbered) of the body portion 210′. Two latch arms 213 are located at lateral sides of the hollow portion 211′. Two platforms 214 are respectively formed on middle sections of the internal sides of the upper and lower wall of the body portion 210′. Two conductive members 215 located at lateral sides of the hollow portion 211′ and supported by stubs 2130 which are connected to middle sections of the latch arms 213.

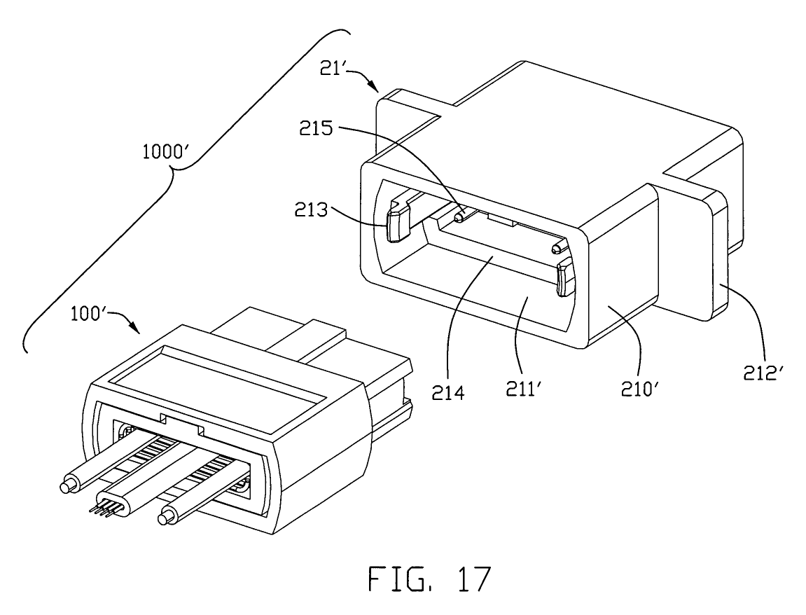

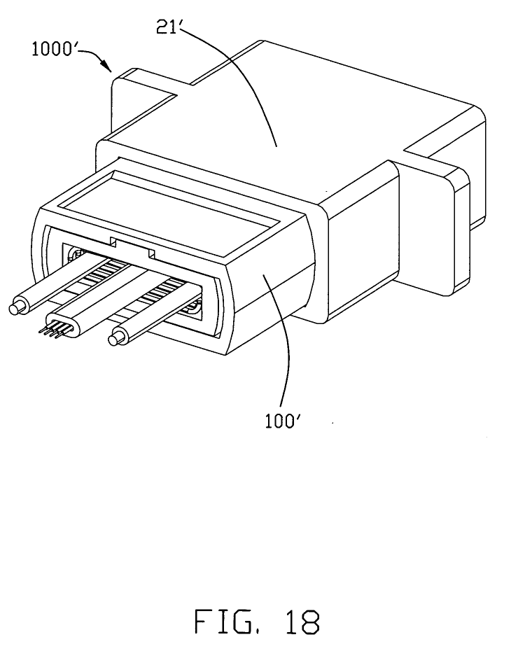

The plug connector 100′ is inserted into the coupler 21′ from front side (see FIGS. 17-18), the latch arms 213 slide along the guiding slots 111 ′ of the inner housing 11 ′ and lock into locking cavities 112′ with a front edge of the outer housing 12′ against the platforms 214, the conductive members 215 inserted into the slots 1034 of the ferrule member 103′ to achieve electrical connection with the contacts 109 therein. Additional plug connector (not shown) substantially same as the plug connector 100′, may be inserted into the coupler 21 from back side. Thus, the plug connector 100′ and the additional plug may coupled together to transmit optical signals as what is illustrated in the first embodiment.

It is to be understood, however, that even though numerous characteristics and advantages of the present invention have been set forth in the foregoing description, together with details of the structure and function of the invention, the disclosure is illustrated only, and changes may be made in detail, especially in matters of shape, size, and arrangement of parts within the principles of the invention to the full extent indicated by the broad general meaning of the terms in which the appended claims are expressed.

What is claimed is:

1. A fiber termination, comprising:
a cable having a number of fibers therein;
a ferrule member combined with the fibers, with front ends of the fibers exposed around a front end portion of the ferrule member; and
a lens member adhesively attached over the front end portion of the ferrule member.

2. The fiber termination as claimed in claim 1, wherein a metallic shielding member encloses the ferrule member and the lens member.

3. The fiber termination as claimed in claim 1, wherein the front ends of the fibers and the front end portion of the ferrule member are polished or cleaved to be substantially flush.

4. The fiber termination as claimed in claim 1, wherein the fibers are epoxied to the ferrule member.

5. The fiber termination as claimed in claim 1, wherein a number of grooves are defined in the ferrule member to accommodate the fibers therein, and wherein adhesive material is applied to the grooves to retain the fibers.

6. The fiber termination as claimed in claim 1, further comprising two contacts and two wires connected to the two contacts, and wherein the ferrule member comprises slots in lateral sides thereof receiving the two contacts.

7. A fiber optic connection system including a plug connector and a receptacle connector, each of the plug connector and the receptacle connector comprising:
a fiber termination comprising:
a cable having a number of fibers therein;
a ferrule member combined with the fibers, with front ends of the fibers exposed around a front end portion of the ferrule member; and
a lens member either over-molded onto the front end portion of the ferrule member.

8. The fiber optic connection system as claimed in claim 7, wherein the front ends of the fibers and the front end portion of the ferrule member are polished or cleaved.

9. The fiber optic connection system as claimed in claim 7, wherein the plug connector has a cover encloses the ferrule member and the lens member.

10. The fiber optic connection system as claimed in claim 9, wherein the cover includes a rear cover attached to the cable and a front cover attached to the rear cover and the ferrule member.

11. The fiber optic connection system as claimed in claim 9, wherein two deflectable latching arms are respectively formed at lateral sides of the cover.

12. The fiber optic connection system as claimed in claim 11, wherein the receptacle connector includes a housing member defining a hollow portion to accommodate the lens member and the ferrule member therein.

13. The fiber optic connection system as claimed in claim 12, wherein two slots are defined in lateral sides of the housing member, and two hook portions are formed on the two deflectable latching arms and locked into the slots.

14. The fiber optic connection system as claimed in claim 12, wherein a clip member links the housing member and the ferrule member together.

15. The fiber optic connection system as claimed in claim 14, wherein clip member includes two arm portions spaced apart from one another and an interconnection portion connected to the two arm portions.

16. The fiber optic connection system as claimed in claim 15, wherein the interconnection portion is accommodated in a groove defined in a rear portion of the housing member, and two latching parts are formed at rear ends of the two arm portions and hold the ferrule member of the receptacle connector.

17. The fiber optic connection system as claimed in claim 15, wherein two spring members are respectively formed at the two arm portions of the clip, and two flange portions project outwardly from the lateral sides of the housing member, and wherein the housing member is mounted to an opening of a panel member, with the spring members and the flange portions disposed at opposite sides of the panel member.

18. The fiber optic connection system as claimed in claim 17, wherein the interconnection portion is received in the opening of the panel member.

19. A fiber optics connection system comprising:
a ferrule member defining a horizontal face with a plurality of upwardly open V-shaped groove sets in said horizontal face and extending through thereof a front edge face which is essentially perpendicular to the horizontal face;
a plurality of optical fibers each including a core received in the corresponding V-shaped groove; and
a lens member defining a cavity circumferentially enclosing a front edge region of the ferrule.

20. The fiber optics connection system as claimed in claim 19, further including an alignment devices to aligned said ferrule member and the lens member in a front-to-back direction along which said V-shaped groove extends.
